(19) United States
(12) Patent Application Publication
(10) Pub. No.: US 2022/0074518 A1
(43) Pub. Date: Mar. 10, 2022

(54) High Pressure Auto Drain Ball Valve

(71) Applicant: Intech Industries, Inc., Wauconda, IL (US)

(72) Inventor: Hongjun Wang, Jiangsu (CN)

(73) Assignee: Intech Industries, Inc., Wauconda, IL (US)

(21) Appl. No.: 17/469,240

(22) Filed: Sep. 8, 2021

(30) Foreign Application Priority Data
Sep. 8, 2020 (CN) 202021942834

(51) Int. Cl. F16K 39/06; F16K 5/06; F16K 27/06

(52) U.S. Cl. CPC F16K 39/06; F16K 27/067; F16K 5/0605

(57) ABSTRACT

Disclosed is an auto-drain ball valve with a valve body, a valve bonnet, a valve ball with a circulation hole, and a valve rod. A valve ball hole, which extends from the bottom of the valve ball to the circulation hole, is formed in the valve ball. A rotating shaft at the bottom of the valve ball rotates along with the valve ball and is in threaded connection with an exhaust hole. An axial rotating shaft exhaust hole communicates with a cavity that is formed in the periphery of the rotating shaft. The ball valve is intuitive in structure and provides an exhaust hole that is automatically opened or closed along with rotation of the valve ball to relieve pipeline pressure and extends the service life of the ball valve.

### CROSS-REFERENCE TO CO-PENDING APPLICATION

This application claims the benefit of Chinese patent application No. 202021942834 entitled “Linkage type self-discharge valve” that was filed on Sep. 8, 2020, by applicant Kangcheng (Jiangsu) Machinery Manufacturing Co., Ltd. and inventor Wang Hongjun, the contents of which are herein incorporated by reference.

### FIELD OF THE INVENTION

The present invention relates to a valve, in particular to a linked self-draining valve.

### BACKGROUND OF THE INVENTION

Self-draining ball valves that are currently available include a valve body and a ball body that are brass. The two ends of the ball valve are threaded, and the bottom of the valve body has an exhausting hole. When the ball valve is closed, gas is exhausted from the exhausting hole at the bottom of the ball valve. The maximum working pressure of existing ball valves is 200 pounds per square inch (PSI), which excludes the usage of ball valves in higher pressure working environments. During operation of existing valves, when the ball valve is open fully, the high pressure causes deformation between the ball body and the ball seat, and the deformation will eventually lead to a liquid or gas leakage when the valve is opened. Additionally, the deformation of the ball body and the ball seat will shorten the life of the ball valve.

### SUMMARY OF THE INVENTION

A linked self-draining valve is presented with an intuitive structure and an exhausting hole which can open or close automatically with the rotation of the valve ball. The design helps to relieve the pipe pressure and prolong the life of the ball valve.

In order to achieve the above purpose, the solution of the design is a linked self-draining valve which includes a valve body, a valve cap, a valve ball with a flow hole, and a valve stem, wherein the valve cap is fixed to the end of the valve body to form a chamber (with two ball seats) that is used to contain the valve ball which can rotate. The valve stem is rotatably connected to the valve body, and one end is fixed to the valve ball. The valve body has a first flow hole, the valve cap has a second flow hole, and the valve body has an exhausting hole whose end is secured with a sealing valve cap where there is an exhausting hole. A valve ball hole with a central hole is formed between the sealing valve cap and the end of the exhaust hole, and the valve ball hole communicates with the first flow hole or the second flow hole formed in the valve ball.

A rotating shaft at the bottom of the valve ball rotates with the valve ball and is threaded with the exhaust hole. There is a rotating shaft exhausting hole at the outer circumference of the rotating shaft that is connected to the chamber axially. The outer periphery of the rotating shaft is provided with an axial exhaust hole communicating with the chamber.

When the valve ball is opened, the rotating shaft descends through the central hole of the sealing device and inserts into the exhausting hole of the sealing valve cap to close the exhausting hole. When the ball valve is closed, the rotating shaft rises, and the gas or liquid in the chamber can flow through the exhausting hole of the rotating shaft and flow out from the exhausting hole of the valve cap.

The valve rod may also include a handle, wherein the other end of the valve rod extends out of the valve body and is fixedly connected with the handle via a nut.

The first flow hole on the valve body and the second flow hole on the valve cap both may have internal threads.

There may also be a valve ball seat between the valve body and joint of the valve cap and the valve ball.

There may also be a limiting slot at the bottom of the valve ball. The upper part of the rotating shaft is placed in the limiting slot and is fitted in the plane, and the lower part of the rotating shaft is threaded with the exhausting hole.

The structure described above has the advantage that, since the bottom of the valve ball is fixedly extended into the rotating shaft of the exhaust hole, when the valve ball is opened, the valve ball drives the rotating shaft to descend through the central bore of the sealing filler into the bonnet exhaust hole of the sealing bonnet (i.e., closing the exhaust hole ensures that a gas or liquid does not leak). When the valve ball is closed, the valve ball raises the rotating shaft, such that the gas or liquid in the chamber can flow through the valve ball hole and out of the exhaust hole of the rotating shaft and valve cap to relieve the pressure. Therefore, the valve ball valve has an elegantly intuitive structure that automatically opens and closes the exhaust hole with the rotation of the ball valve to relieve pressure and extend the service life of the valve.

### BRIEF DESCRIPTION OF THE DRAWINGS

Each of the drawing figures now described shows an exemplary embodiment of the present invention.

FIG. 1 is an elevational cross-sectional view of a valve in an open configuration.

FIG. 2 is an elevational cross-sectional view of a valve in a closed configuration.

FIG. 3 is an enlarged view of part I of FIG. 1.

FIG. 4 is an enlarged view of part II in FIG. 2.

FIG. 5 is an elevational cross-sectional view of a valve in an open configuration.

FIG. 6 is an elevational cross-sectional view of a valve in a closed configuration.

### DETAILED DESCRIPTION OF THE PREFERRED EMBODIMENTS

The present invention may be used with any type of valve and is particularly suited for use with high pressure systems.

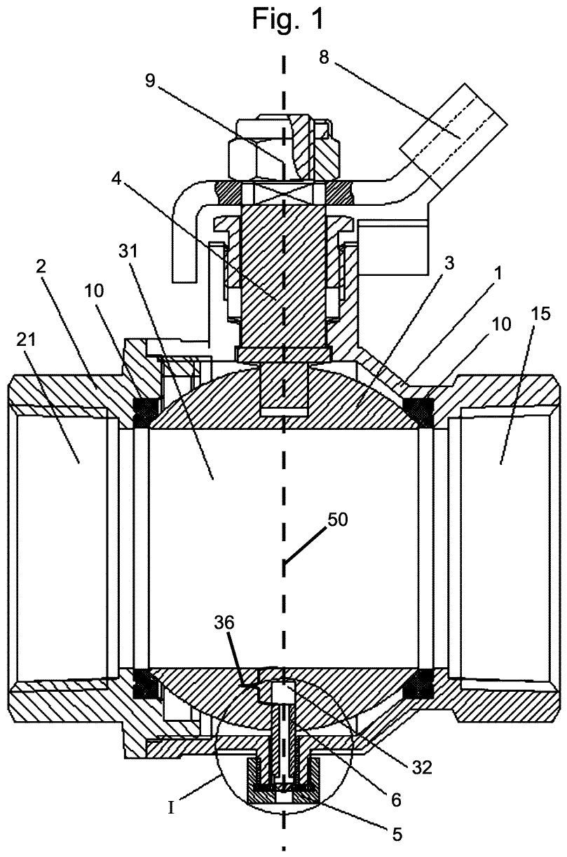

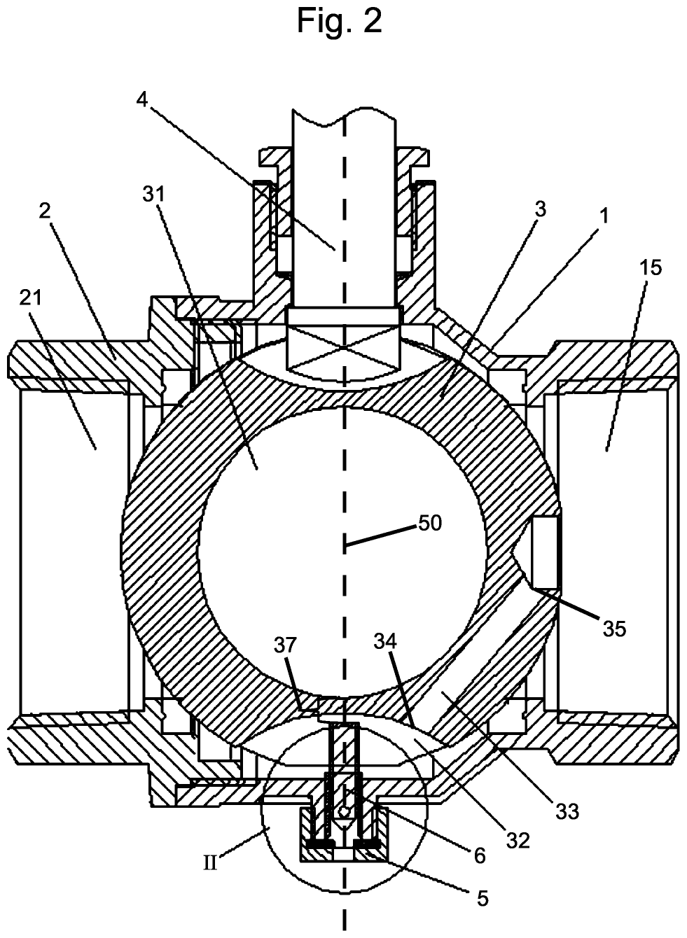

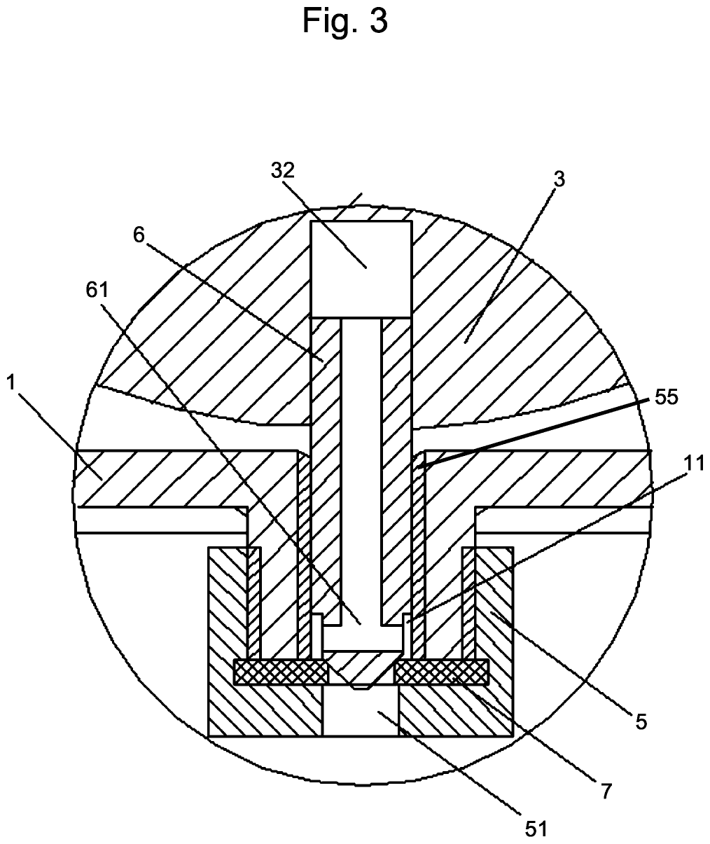

FIGS. 1, 2, 3, and 4 show a high pressure auto drain ball valve with a valve body 1, a valve cap 2, a valve ball 3 with a flow hole 31, and a valve stem 4 wherein the valve cap 2 is fix to the end of the valve body 1 to form a chamber that contains the valve ball 3. The valve ball 3 can rotate about an axis of rotation 50 (vertically up and down in FIGS. 1 and 2). The valve stem 4 is rotatably connected to the valve body 1 that has an end fixed to the valve ball 3. In one embodiment, there is a first flow hole 15 on the valve body 1 and a second flow hole 21 on the valve cap 2. As shown in FIG. 3, there is also an exhausting hole 11 on the valve body 1. The end of the exhausting hole 11 is fixed with the sealing valve cap 5 that includes an exhausting hole 51. There is a sealing ring 7 with a center hole between the sealing valve cap 5 and the end of the exhausting hole 11. There is a valve ball hole 33 on the valve ball 3 which can connect with the first or second flow holes (15, 21). The valve ball hole 33 has a first end 34 proximate to the cavity (or limiting slot) 32 and a second end 35 distant from the cavity 32. When the valve is in the closed configuration, the second end 35 of the valve ball hole 33 connects with the first or second flow holes (15, 21). There is a rotating shaft 6 rotating with the valve ball 3 that is threaded with the threads 55 of the exhausting hole 11 at the bottom of the valve ball. There is an exhausting hole 61 at the outer circumference of the rotating shaft 6 which is connected to the chamber axially.

FIG. 1 shows a valve in an open configuration where the flow hole 31 of the valve ball is aligned with the first and second flow holes (15, 21) to allow a fluid or gas to pass through the valve. FIG. 2 shows a valve in a closed configuration where the flow hole 31 is unaligned with the first and second flow holes (15, 21) such that the flow of fluid or gas through the valve is blocked.

Referring to FIGS. 1 and 2, the valve also includes a handle 8. The other end of the valve stem 4 extends out of the valve body 1 and is fixed to the handle 8 by a nut 9. The handle 8 can rotate the valve stem 4 and drive the valve ball 3 to rotate so as to open or close the valve ball 3.

Referring to FIGS. 1 and 2, the first flow hole 15 on the valve body 1 and the second flow hole 21 on the valve cap 2 both have internal threads to allow for convenient connection to pipelines or equipment on both sides. In other embodiments of the invention, the flow holes (15, 21) are smooth to facilitate other types of connections (e.g., soldering or welding).

Referring to FIGS. 1 and 2, there is a valve ball seat 10 between (i) the valve body 1 and the valve ball 3 and (ii) the joint of the valve cap 2 and the valve ball 3 so as to prevent the valve ball 3 from slipping during rotation. The valve body 1, the valve cap 2, and the two ball seats 10 cooperate to form the chamber.

Referring to FIGS. 1 and 2, there is a cavity or limiting slot 32 at the bottom of the valve ball 3. The upper part of the rotating shaft 6 is placed in the limiting slot 3 and is fitted in the plane, and the lower part is threaded with the exhausting hole 11. The section of the upper part of the valve ball 3 is quadrilateral, and the two opposite surfaces cooperate with the two side walls of the limiting slot 32 to drive the rotating shaft 6 to rotate without restricting the lifting movement of the rotating shaft 6. Due to the shape of the cavity 32 (or limiting slot), the rotating shaft 6 is rotationally locked to the valve ball, and the rotating shaft rotates when the valve ball rotates. As shown in FIGS. 1 and 2, the axis of rotation 50 of the valve ball 3 passes through the rotating shaft 6. Due to the up and down movement of the rotating shaft 6, when the valve is in the open configuration (shown in FIG. 1), the rotating shaft 6 is a first distance 36 from the flow hole 31; and when the valve is in the closed configuration (shown in FIG. 2), the rotating shaft 6 is a second distance 37 from the flow hole 31. The second distance 37 is less than the first distance 36.

When the valve is used, as shown in FIGS. 1 and 3, the valve ball 3 is rotated by the handle 8 to a position where the flow hole 31 of the valve ball 3 connects to the first flow hole 15 on the valve body 1 to the second flow hole 21 on the cap 2 to form a passage through which gas or liquid can flow to open the ball valve 3.

When the valve ball 3 is opened, the valve ball 3 drives the rotating shaft 6 to rotate. As the lower end of the rotating shaft 6 and the exhausting hole 11 are connected by threading 55, the rotating shaft 6 falls through the central hole of the sealing ring 7 and inserts the exhausting hole 51 of the sealing valve cap 5 to close the exhausting hole 11 so as to avoid gas or liquid leakage. As shown in FIG. 3, when the valve is in the open configuration, the rotating shaft 6 directly contacts the sealing ring 7.

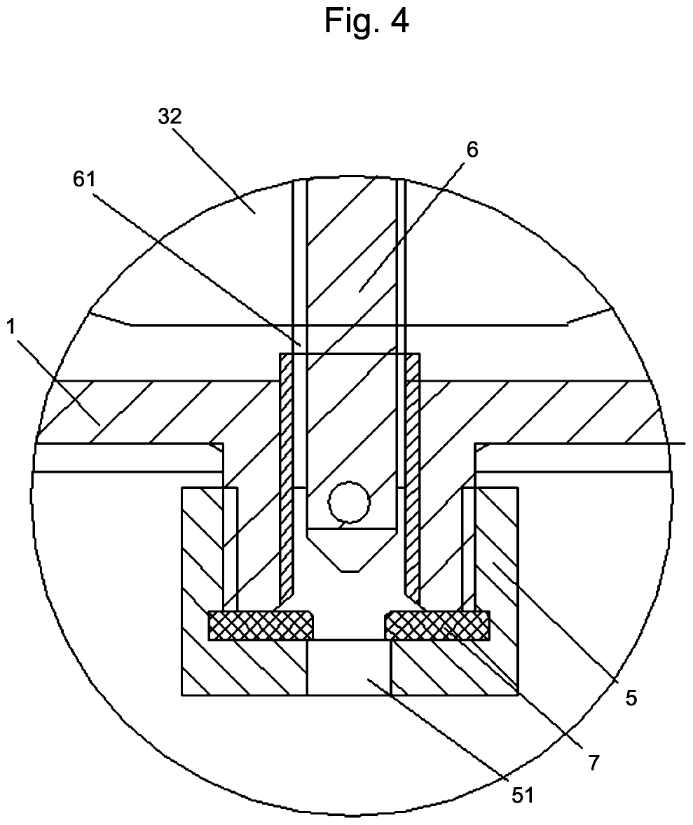

Referring to FIGS. 2 and 4, when the valve ball 3 is closed, the handle 8 drives the valve ball 3 to rotate, disconnecting the connection between the first flow hole 15 on the valve body 1 and the second flow hole 21 on the cap 2. At the same time, the valve ball 3 drives the rotating shaft 6 to rotate, the rotating shaft 6 rises, and the gas or liquid in the chamber can flow through the exhausting hole 33 of the shaft and flow out from the exhausting hole 51 of the cap to relieve pressure. Therefore, the device has an intuitive structure and the exhaust hole 11 can open or close automatically with the rotation of the valve ball 3. By draining the gas or liquid, the pipe pressure is relieved, and the life of the ball valve is prolonged. As shown in FIG. 4, when the valve is in the closed configuration, the rotating shaft 6 is separated from the sealing ring 7.

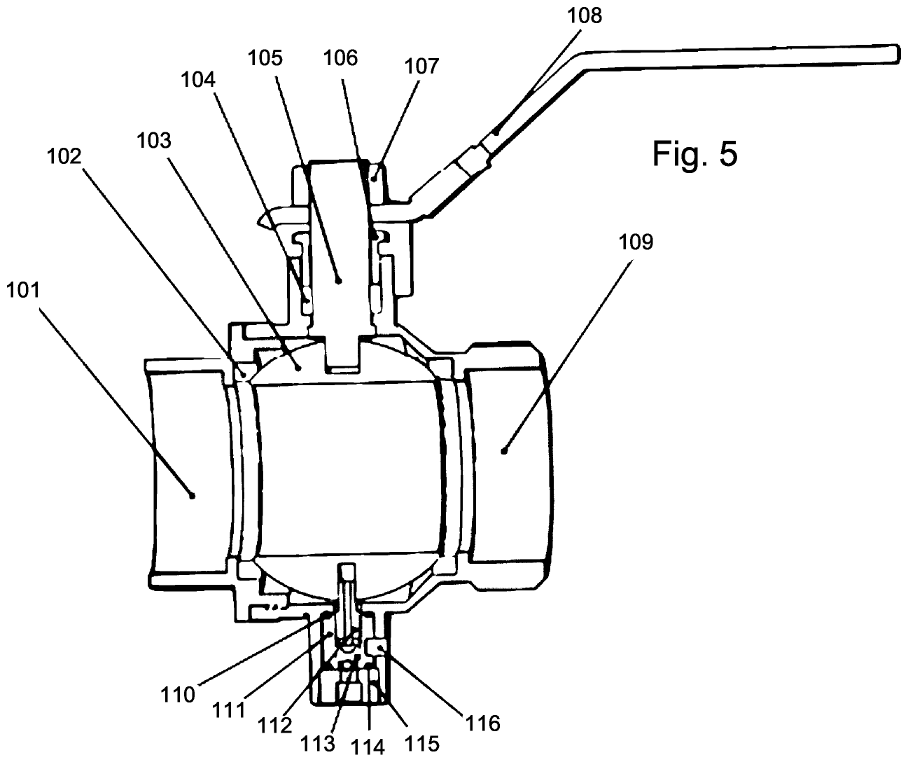

FIG. 5 shows a second embodiment of the valve shown in FIGS. 1-4. The components of the valve, and their exemplary materials, are shown in the following table.

| Item | Name | Material |
|---|---|---|
| 101 | Cap | Brass |
| 102 | Ball Seats | PTFE (Polytetrafluoroethylene) |
| 103 | Ball | Brass |
| 104 | Packing | PTFE |
| 105 | Stem | Brass |
| 106 | Packing Nut | Brass |
| 107 | Nut | Steel |
| 108 | Handle | Steel |
| 109 | Body | Brass |
| 110 | O-Ring | Rubber |
| 111 | Needle Seat | Brass |
| 112 | Needle | Brass |
| 113 | Needle Sealing | PTFE |
| 114 | O-Ring | Rubber |
| 115 | Plug | Brass |
| 116 | Locking Pin | Steel |

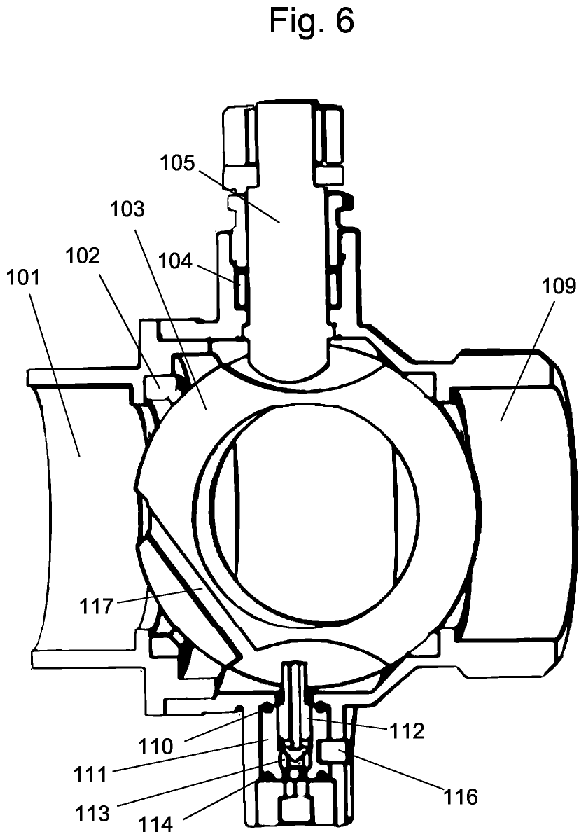

FIG. 6 shows the valve of FIG. 5 in the closed configuration. The names of the components listed in the table associated with FIGS. 5 and 6 may be used interchangeably with the component names used in FIGS. 1-4. For example, needle 112 may be used interchangeably with rotating shaft 6, and needle sealing 113 may be used interchangeably with sealing ring 7.

In the valve shown in FIGS. 5 and 6, the ball 103 is rotatable by 90 degree through the valve stem 106 for valve's fully opening (FIG. 5) and closing (FIG. 6). The exhaust 117 hole goes though the ball 103 from one side to the bottom of the ball 103. The residual air on the down-stream side (101 in FIG. 6) can automatically and continuously be vented though the hole 117. The valve includes a stop valve (collectively items 110-116) to close the bottom exhaust port when the valve is in the open position and open the exhaust port when the ball valve is at closed position. When the stem 106 and the ball 103 are 90 degree clockwise turned for ball valve's closing, the needle 102 of the stop valve is turned counterclockwise to open the stop valve accordingly.

While the principles of the invention have been shown and described in connection with specific embodiments, it is to be understood that such embodiments are by way of example and are not limiting. Consequently, variations and modifications commensurate with the above teachings, and with the skill and knowledge of the relevant art, are within the scope of the present invention. The embodiments described herein are intended to illustrate best modes known of practicing the invention and to enable others skilled in the art to utilize the invention with various modifications required by the particular application(s) or use(s) of the present invention. It is intended that the appended claims be construed to include alternative embodiments to the extent permitted by the prior art.

What is claimed:

1. An auto-drain ball valve, comprising:
a body with
a first circulation hole and
an exhaust hole with a threading;
a valve cap with a second circulation hole;
the body
secured to the valve cap and
cooperating with the valve cap to form a chamber;
the valve ball
having a flowthrough hole
secured within the chamber,
having a cavity located adjacent to the exhaust hole, and
having a channel extending through the valve ball with
a first end of the channel proximate to the exhaust hole and
a second end of the channel distant from the exhaust hole;
a rotating shaft
partially located within the cavity of the valve ball,
rotationally locked to the valve ball, and
connected to the treading of the body, wherein
the threading is configured to move the rotating shaft further into or out of the cavity of the valve ball when the valve ball is rotated;
the auto-drain ball valve having an open configuration wherein
the first circulation hole of the body, the second circulation hole of the valve cap, and the flowthrough hole of the valve ball are aligned to enable a fluid or gas to pass through the auto-drain ball valve,
the rotating shaft seals the exhaust hole to prevent the fluid or gas from passing through the exhaust hole, and
the second end of the channel is distant from both the first circulation hole and the second circulation hole; and
the auto-drain ball valve having a closed configuration wherein
the flowthrough hole of the valve ball is unaligned with the first circulation hole of the body and the second circulation hole of the valve cap to prevent the fluid or gas from passing through the auto-drain ball valve,
the rotating shaft is disengaged from the exhaust hole to enable the fluid or gas to pass through the exhaust hole, and
the second end of the channel is adjacent to either the first circulation hole or the second circulation hole to enable the fluid or gas in the chamber to vent from the chamber through the channel to the exhaust hole.

2. The auto-drain ball valve of claim 1 further comprising
a stem
rotatably connected to the body and
fixedly secured to the valve ball.

3. The auto-drain ball valve of claim 2 further comprising
a handle secured to the stem with a nut.

4. The auto-drain ball valve of claim 1 further comprising
a sealing cap
secured to the exhaust hole,
having a vent hole aligned with the exhaust hole, and
having a sealing ring adjacent to the exhaust hole.

5. The auto-drain ball valve of claim 4 wherein
the rotating shaft
directly contacts the sealing ring when the auto-drain ball valve is in the open configuration and
is spaced apart from a sealing filler when the auto-drain ball valve is in the closed configuration.

6. The auto-drain ball valve of claim 1, wherein
both
the first circulation hole of the body and
the second circulation hole of the valve cap
have internal threads configured to receive a pipe connection.

7. The auto-drain ball valve of claim 1, wherein
the valve ball includes a limiting groove adjacent to the rotating shaft configured to limit rotation of the valve ball.

8. The auto-drain ball valve of claim 1, wherein
the valve ball is configured to rotate about an axis of rotation from a first orientation when the auto-drain ball valve is in the open configuration to a second orientation when the auto-drain ball valve is in the closed configuration; and
the axis of rotation extends through the rotating shaft.

9. The auto-drain ball valve of claim 1, wherein
the rotating shaft is a first distance from the flowthrough hole when the auto-drain ball valve is in the open configuration;
the rotating shaft is a second distance from the flowthrough hole when the auto-drain ball valve is in the closed configuration; and
the second distance is greater than the first distance.

10. The auto-drain ball valve of claim 1 further comprising
a first valve ball seat adjacent to the first circulation hole;
a second valve ball seat adjacent to the second circulation hole;
wherein
the body, the valve cap, the first valve ball seat, and the second valve ball seat cooperate to form the chamber.

11. An auto-drain ball valve, comprising:
a body with
a first circulation hole and
an exhaust hole;
a valve cap with a second circulation hole;
the body
secured to the valve cap and
cooperating with the valve cap to form a chamber;
the valve ball
having a flowthrough hole
secured within the chamber,
having a cavity located adjacent to the exhaust hole, and
having a channel extending through the valve ball with
a first end of the channel proximate to the cavity and
a second end of the channel distant from the cavity;
a needle
partially located within the cavity of the valve ball,
rotationally locked to the valve ball,
connected to the treading of the body, and
configured to move the needle further into or out of the cavity of the valve ball when the valve ball is rotated;
the auto-drain ball valve having an open configuration wherein
the first circulation hole of the body, the second circulation hole of the valve cap, and the flowthrough hole of the valve ball are aligned to enable a fluid or gas to pass through the auto-drain ball valve,
the needle seals the exhaust hole to prevent the fluid or gas from passing through the exhaust hole, and
the second end of the channel is distant from both the first circulation hole and the second circulation hole; and
the auto-drain ball valve having a closed configuration wherein the flowthrough hole of the valve ball is unaligned with the first circulation hole of the body and the second circulation hole of the valve cap to prevent the fluid or gas from passing through the auto-drain ball valve,
the needle is disengaged from the exhaust hole to enable the fluid or gas to pass through the exhaust hole, and
the second end of the channel is adjacent to either the first circulation hole or the second circulation hole to enable fluid or gas in the chamber to vent from the chamber through the channel to the exhaust hole.

12. The auto-drain ball valve of claim 11 further comprising
a stem
rotatably connected to the body and
fixedly secured to the valve ball.

13. The auto-drain ball valve of claim 12 further comprising
a handle secured to the stem with a nut.

14. The auto-drain ball valve of claim 11 further comprising
a sealing cap
secured to the exhaust hole,
having a vent hole aligned with the exhaust hole, and
having a sealing ring adjacent to the exhaust hole.

15. The auto-drain ball valve of claim 14 wherein
the needle
directly contacts the sealing ring when the auto-drain ball valve is in the open configuration and
is spaced apart from a sealing filler when the auto-drain ball valve is in the closed configuration.

16. The auto-drain ball valve of claim 11, wherein
both
the first circulation hole of the body and
the second circulation hole of the valve cap
have internal threads configured to receive a pipe connection.

17. The auto-drain ball valve of claim 11, wherein
the valve ball includes a limiting groove adjacent to the needle configured to limit rotation of the valve ball.

18. The auto-drain ball valve of claim 11, wherein
the valve ball is configured to rotate about an axis of rotation from a first orientation when the auto-drain ball valve is in the open configuration to a second orientation when the auto-drain ball valve is in the closed configuration; and
the axis of rotation extends through the needle.

19. The auto-drain ball valve of claim 11, wherein
the needle is a first distance from the flowthrough hole when the auto-drain ball valve is in the open configuration;
the needle is a second distance from the flowthrough hole when the auto-drain ball valve is in the closed configuration; and
the second distance is greater than the first distance.

20. The auto-drain ball valve of claim 11 further comprising
a first valve ball seat adjacent to the first circulation hole;
a second valve ball seat adjacent to the second circulation hole;
wherein
the body, the valve cap, the first valve ball seat, and the second valve ball seat cooperate to form the chamber.
